(19) United States
(12) Patent Application Publication
(10) Pub. No.: US 2014/0142960 A1
(43) Pub. Date: May 22, 2014

(54) GENERATION OF MEDICAL INFORMATION USING TEXT ANALYTICS

(71) Applicant: INTERNATIONAL BUSINESS MACHINES CORPORATION, Armonk, NY (US)

(72) Inventors: Dhruv A. Bhatt, Indian Trail, NC (US); Kristin E. McNeil, Charlotte, NC (US); Nitaben A. Patel, Charlotte, NC (US)

(73) Assignee: International Business Machines Corporation, Armonk, NY (US)

(21) Appl. No.: 13/678,628

(22) Filed: Nov. 16, 2012

(51) Int. Cl. G06Q 50/22

(52) U.S. Cl. CPC G06Q 50/22
USPC 705/2

(57) ABSTRACT

A computer generates medical information that can include one or more of a patient awareness report and a follow-up question, utilizing at least one computing processor. The computer identifies a medical document, and annotates the medical document using a plurality of annotators to produce annotations associated with the medical document. The computer determines a medical condition based, at least in part, on the annotations, and generates medical information related to the medical condition based, at least in part, on the annotations. The computer can identify a knowledge domain of the medical document, and the computer can identify at least one of the annotators based on the knowledge domain of the medical document.

### FIELD OF THE INVENTION

The present invention relates generally to the generation of medical information, and more particularly to generation of medical information using a text analytics technique.

### BACKGROUND

In the healthcare setting, patient education typically leads to time savings and cost reductions, as well as to improvements in patient satisfaction, better health outcomes, better compliance, more empowered patient decision making, and reduced medical malpractice. In that healthcare setting, where there is relentless pressure to reduce costs, patient education can serve as a cost savings tool.

The market for patient education is very large. In the United States, patients typically visit their doctors hundreds of millions of times per year in the aggregate, and have surgeries tens of millions of times per year in the aggregate. Each of these encounters between a patient and the healthcare system generates an opportunity for patient education.

A variety of tools are used for patient education. The primary tool for patient education is direct communication, i.e., talking between the healthcare provider and the patient. The provider often uses demonstrations, such as by using previously prepared or contemporaneously prepared images to supplement the discussion. Written materials, such as brochures, handouts, and other written material can also be provided to the patient. Audiovisual material, such as videos can sometimes be provided to the patient, or given to the patient to watch in their own homes, or in a waiting room or lobby.

Each of these tools has an associated cost in time or materials. In the healthcare setting, providers often do not have enough time to fully explain diagnoses or procedures to patients. Materials that are previously prepared may not explain the particular details that make a particular patient's procedure different than one that is common or routine. Audiovisual materials, with nothing further, do not provide ability for the patient to ask questions or receive interactive feedback. As such, tools for patient education in the healthcare setting presently suffer from limitations.

### SUMMARY

Embodiments of the present invention provide for a program product, system, and method in which a computer generates medical information that can include one or more of a patient awareness report and a follow-up question, utilizing at least one computing processor. The computer identifies a medical document, and annotates the medical document using a plurality of annotators to produce annotations associated with the medical document. The computer determines a medical condition based, at least in part, on the annotations, and generates medical information related to the medical condition based, at least in part, on the annotations. The computer can identify a knowledge domain of the medical document, and the computer can identify at least one of the annotators based on the knowledge domain of the medical document.

### BRIEF DESCRIPTION OF THE SEVERAL VIEWS OF THE DRAWINGS

FIG. 1 is a functional block diagram of a medical environment in accordance with an embodiment of the present invention.

FIG. 2 is a flowchart depicting steps followed by a client program of a user device and by a medical analytics program of a medical analytics server during the generation of a patient awareness report and follow-up questions in accordance with an embodiment of the present invention.

FIG. 3 is a functional block diagram of a computer system in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor (i.e., a computing processor) of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

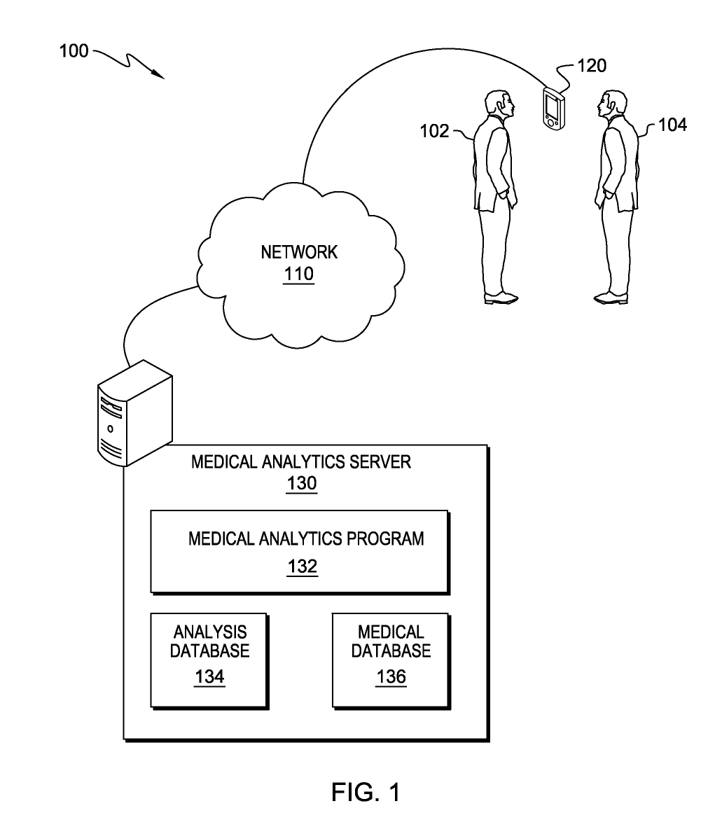

Referring now to FIG. 1, a functional block diagram of medical environment 100 in accordance with an embodiment of the present invention is shown. Medical environment 100 includes network 110, user device 120, and medical analytics server 130. Network 110 can be, for example, a local area network (LAN), a wide area network (WAN) such as the Internet, or a combination of the two, and can include wired or wireless connections. In general, network 110 can be any combination of connections and protocols that will support communications via various channels between user device 120 and medical analytics server 130 in accordance with an embodiment of the invention. As will be discussed in detail below, person 102, a patient in medical environment 100, can utilize user device 120 to generate a patient awareness report and follow-up questions for person 104, a doctor or other healthcare provider in medical environment 100. In one embodiment, the generation can occur in real-time to facilitate a timely interaction between person 102 and person 104. In various embodiments, materials in addition to patient awareness reports and follow-up questions can be generated and displayed. As such, the current technique is not limited to patient awareness reports and follow-up questions, but can include any kind of medical information.

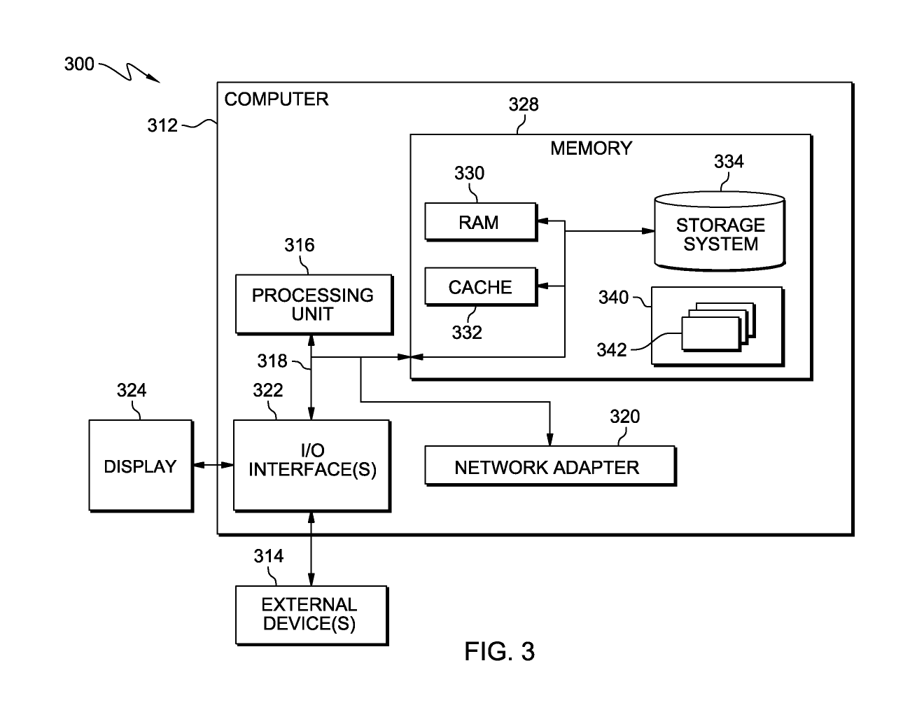

In various embodiments, each one of user device 120 and medical analytics server 130 can include a laptop, tablet, or netbook personal computer (PC), a desktop computer, a personal digital assistant (PDA), a smart phone, a mainframe computer, or a networked server computer. Further, medical analytics server 130 can include computing systems utilizing clustered computers and components to act as single pools of seamless resources when accessed through network 110, or can represent one or more cloud computing datacenters. In general, each one of user device 120 and medical analytics server 130 can be any programmable electronic device as described in further detail with respect to FIG. 3. In one embodiment, the current technique can be implemented entirely in one device, such as in user device 120.

User device 120 includes a client program (not shown) for gathering medical documents, transmitting the medical documents to medical analytics server 130 via network 110, and for receiving a resulting patient awareness report and follow-up questions from medical analytics server 130. The client program can include a cryptographic module for encrypting and decrypting these transmissions, in order to protect the privacy of the transmitted information. Medical documents can include a doctor's note written by person 104, a medical lab report detailing results of lab tests performed on person 102, a prescription for medication for person 102, or a transcript of a spoken conversation between person 102 and person 104 generated by user device 120, for example. In particular, the client program of user device 120 can image the former three examples of medical documents utilizing a camera or scanner of user device 120, or can generate a transcript of a spoken conversation utilizing a microphone and a voice recognition module, for example. In general, medical documents can include information in any format. Responsive to receiving the resulting patient awareness report and follow-up questions, user device 120 can display them on a user interface to person 102, to facilitate patient education of person 102 and to further conversation between person 102 and person 104.

Medical analytics server 130 can communicate with user device 120 via a client program of user device 120, as discussed above. Medical analytics server 130 includes medical analytics program 132, which performs text analytics against the medical documents received from user device 120, and which augments the results of the text analytics to generate a patient awareness report and follow-up questions, utilizing analysis database 134 and medical database 136. Medical analytics program 132 can also include a cryptographic module for encrypting and decrypting transmitted information, and can further include safeguards against the unauthorized further dissemination of transmitted information, in order to protect the privacy of the transmitted information. Databases 134 and 136 are not limited to being data repository databases, and in various embodiments can be files, file systems, or even programs. Text analytics can be performed using an Unstructured Information Management Architecture (UIMA) application configured to analyze unstructured information to discover patterns.

Medical analytics program 132 utilizes the contents of analysis database 134 to annotate the medical documents received from user device 120. The contents of analysis database 134 include annotators which consist of rules and dictionaries, for example. Medical analytics program 132 can maintain an analysis structure in analysis database 134, which provides the annotators with a facility for efficiently building and searching the analysis structure. The analysis structure is a data structure that is mainly composed of meta-data descriptive of sub-sequences of the text of the medical documents received from user device 120. An exemplary type of meta-data in an analysis structure is an annotation. An annotation is an object, with its own properties, that is used to annotate a sequence of text. There are an arbitrary number of types of annotations. For example, annotations may label sequences of text in terms of their role in the medical document's structure (e.g., word, sentence, paragraph, etc.), or to describe them in terms of their grammatical role (e.g., noun, noun phrase, verb, adjective, etc.). Annotations may further determine the knowledge domain of a medical document (e.g., the prescription drug domain, the surgical procedure domain, etc.) Further still, annotators may identify sequences of text indicating medical conditions, diseases, injuries, symptoms, or medical recommendations, for example. There is essentially no limit on the number of, or application of, annotations. Other examples include annotating segments of text to identify them as proper names, locations, times, events, equipment, conditions, temporal conditions, relations, biological relations, family relations, or other items of significance or interest. Annotating the medical documents can further include determining the knowledge domain of the medical documents, as a prelude to narrowing a range of further applicable annotators, or as a part of identifying domain-specific parts of speech in the medical documents, or in order to select domain-specific rules and dictionaries.

Having utilized the contents of analysis database 134 to annotate the medical documents received from user device 120, medical analytics program 132 has generated a resulting analysis structure in analysis database 134. Having done so, medical analytics program 132 can then augment the results of the text analytics to determine a medical condition and to generate a patient awareness report and follow-up questions, utilizing analysis database 134, medical database 136, or both. Medical database 136 includes a medical ontology from one or more sources. For example, the medical ontology can include a set of logical axioms designed to account for the intended meaning of a vocabulary. Further, the medical ontology can include a catalog of the types of things (e.g., medical objects, subjects, events, etc.) that are assumed to exist in the medical domain of interest from the perspective of a person (e.g., doctors, nurses, patients, etc.) who uses a language for the purpose of talking about the medical domain of interest. As such, medical database 136 includes a datastore of medical knowledge.

Medical analytics program 132 can augment the results of the text analytics to determine a medical condition and to generate a patient awareness report and follow-up questions utilizing analysis database 134, medical database 136, or both, by searching for annotations or combinations of annotations, stored in the analysis structure of analysis database 134, in at least medical database 136. For example, if the analysis structure includes one or more annotations related to a particular ailment, then medical analytics program 132 can augment the results of the text analytics by searching for the particular ailment in the medical ontology of medical database 136. For instance, if an annotation relates to a lung ailment, then searching for the lung ailment in the medical ontology will yield logical axioms related to the lung ailment, as well as relevant things connected to the lung ailment in the catalog. The results of the search can be used to augment the results of the text analytics. For example, the medical condition can be determined to be the lung ailment, and a patient awareness report can be generated that includes definitions, found in the medical ontology, of annotations or combination of annotations stored in the analysis structure. Further, follow-up questions can be generated that include questions directed to terms found in the medical ontology.

As a particular example, in one instance person 102 is admitted to a hospital, included in medical environment 100, with a leg infection. Previously prescribed antibiotics have not been effective in healing the leg infection, even though the antibiotics have been given directly into the blood stream of person 102. Because person 102 also has diabetes and hypertension, his or her doctor, person 104, has determined that person 102 may have peripheral artery disease preventing the antibiotics from reaching the infected area, and has thus decided to perform a peripheral angiography test. As part of the test, catheters will be inserted into the legs of person 102. Person 104 informs person 102 of this information verbally, and also states that the test procedure has many risks including acute renal failure.

Person 102 may have substantial difficulty in understanding some or all of the information related by person 104. However, by use of the techniques introduced herein, person 102 can receive a patient awareness report via user device 120. The patient awareness report can explain details about the disease, such as by explaining that peripheral artery disease is a disease common in diabetic patients. In the disease, plaque builds up in arteries which can lead to decreased or blocked blood circulation throughout hands, legs, head, and other organs. The patient awareness report can also explain that hypertension is a condition of having high blood pressure. Further, the patient awareness report can explain details about the diagnosis, such as by explaining that a peripheral angiography test is performed to show the blood flow in the legs. Further still, the patient awareness report can explain details about the risk, such as by explaining that renal failure is a medical term for kidney failure, and that one of the symptoms of kidney failure is little or no urine output, and further that due to the risk of renal failure, person 102 should drink water after the procedure to reduce the risk, but should avoid drinking any color-added drinks like soda. Additionally, by use of the techniques introduced herein, person 102 can receive follow-up questions via user device 120. The follow-up questions can include “do I need to stop drinking/eating before the procedure,” and “do I need to continue with all my medication on the day of the procedure,” for example.

Thus, having augmented the results of the text analytics to determine the medical condition and to generate a patient awareness report and follow-up questions, medical analytics program 132 can transmit the patient awareness report and follow-up questions to user device 120, which can display them on a user interface to person 102, to facilitate patient education of person 102 and to further conversation between person 102 and person 104.

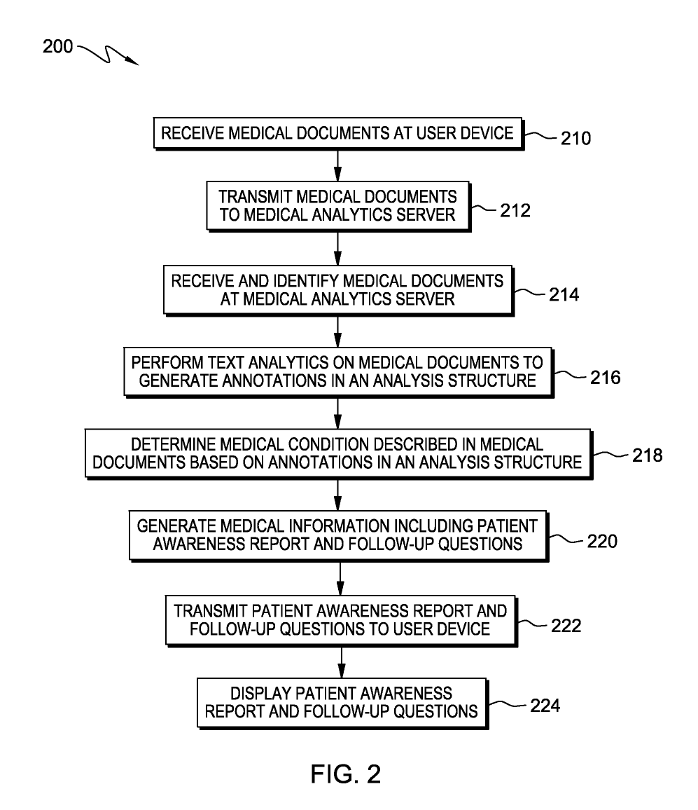

FIG. 2 shows flowchart 200 depicting steps followed by a client program of user device 120 and by medical analytics program 132 of medical analytics server 130 during the generation of a patient awareness report and follow-up questions in accordance with an embodiment of the present invention. In step 210, a client program of user device 120 receives medical documents. The medical documents can include, for example, a doctor's note written by person 104, a medical lab report detailing results of lab tests performed on person 102, or a prescription for medication for person 102, imaged with a camera of user device 120; or a transcript of a spoken conversation between person 102 and person 104 generated by a voice recognition module of user device 120. In step 212, the client program of user device 120 transmits the medical documents to medical analytics program 132 of medical analytics server 130. In step 214, medical analytics program 132 receives and identifies the medical documents at medical analytics server 130.

In step 216, medical analytics program 132 performs text analytics on the medical documents to generate an analysis structure including annotations, which can be stored in analysis database 134, for example. Text analytics can be performed using an Unstructured Information Management Architecture (UIMA) application configured to analyze unstructured information to discover patterns. The analysis structure is mainly composed of meta-data descriptive of sub-sequences of the text of the medical documents received from user device 120. In step 218, medical analytics program 132 determines a medical condition described in the medical documents based on the analysis structure including annotations, and in step 220 medical analytics program 132 generates medical information including a patient awareness report and follow-up questions. Determining the medical condition and generating the patient awareness report and follow-up questions can be performed by, for example, searching for annotations or combinations of annotations, stored in the analysis structure of analysis database 134, in at least medical database 136.

In step 222, medical analytics program 132 transmits the patient awareness report and follow-up questions to the client program of user device 120, and in step 224 the client program displays the patient awareness report and follow-up questions to a user of user device 120. By doing so, the patient education of person 102 and further conversation between person 102 and person 104 are facilitated.

Referring now to FIG. 3, a functional block diagram of a computer system in accordance with an embodiment of the present invention is shown. Computer system 300 is only one example of a suitable computer system and is not intended to suggest any limitation as to the scope of use or functionality of embodiments of the invention described herein. Regardless, computer system 300 is capable of being implemented and/or performing any of the functionality set forth hereinabove.

In computer system 300 there is computer 312, which is operational with numerous other general purpose or special purpose computing system environments or configurations. Examples of well-known computing systems, environments, and/or configurations that may be suitable for use with computer 312 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of user device 120 and medical analytics server 130 can include or can be implemented as an instance of computer 312.

Computer 312 may be described in the general context of computer system executable instructions, such as program modules, being executed by a computer system. Generally, program modules may include routines, programs, objects, components, logic, data structures, and so on that perform particular tasks or implement particular abstract data types. Computer 312 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 3, computer 312 in computer system 300 is shown in the form of a general-purpose computing device. The components of computer 312 may include, but are not limited to, one or more processors or processing units 316, memory 328, and bus 318 that couples various system components including memory 328 to processing unit 316.

Bus 318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 312 typically includes a variety of computer system readable media. Such media may be any available media that is accessible by computer 312, and includes both volatile and non-volatile media, and removable and non-removable media.

Memory 328 can include computer system readable media in the form of volatile memory, such as random access memory (RAM) 330 and/or cache 332. Computer 312 may further include other removable/non-removable, volatile/non-volatile computer system storage media. By way of example only, storage system 334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 318 by one or more data media interfaces. As will be further depicted and described below, memory 328 may include at least one program product having a set (e.g., at least one) of program modules that are configured to carry out the functions of embodiments of the invention.

Program 340, having one or more program modules 342, may be stored in memory 328 by way of example, and not limitation, as well as an operating system, one or more application programs, other program modules, and program data. Each of the operating system, one or more application programs, other program modules, and program data or some combination thereof, may include an implementation of a networking environment. Program modules 342 generally carry out the functions and/or methodologies of embodiments of the invention as described herein. Medical analytics program 132 can be implemented as or can be an instance of program 340.

Computer 312 may also communicate with one or more external devices 314 such as a keyboard, a pointing device, etc., as well as display 324; one or more devices that enable a user to interact with computer 312; and/or any devices (e.g., network card, modem, etc.) that enable computer 312 to communicate with one or more other computing devices. Such communication can occur via Input/Output (I/O) interfaces 322. Still yet, computer 312 can communicate with one or more networks such as a local area network (LAN), a general wide area network (WAN), and/or a public network (e.g., the Internet) via network adapter 320. As depicted, network adapter 320 communicates with the other components of computer 312 via bus 318. It should be understood that although not shown, other hardware and/or software components could be used in conjunction with computer 312. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1-7. (canceled)

8. A computer program product for generating medical information, the computer program product comprising:
one or more computer-readable tangible storage devices and program instructions stored on at least one of the one or more storage devices, the program instructions comprising:
program instruction to identify a medical document;
program instruction to annotate the medical document using a plurality of annotators to produce annotations associated with the medical document;
program instruction to determine a medical condition based, at least in part, on the annotations; and
program instruction to generate medical information related to the medical condition based, at least in part, on the annotations.

9. The computer program product of claim 8, further comprising:
program instruction to identify a knowledge domain of the medical document.

10. The computer program product of claim 9, further comprising:
program instruction to identify at least one of the annotators based on the knowledge domain of the medical document.

11. The computer program product of claim 8, wherein the medical information includes one or more of a patient awareness report and a follow-up question.

12. The computer program product of claim 8, wherein determining the medical condition includes searching for at least one of the annotations in a medical database.

13. The computer program product of claim 12, wherein the medical database includes an ontology.

14. The computer program product of claim 8, wherein the medical document is generated utilizing one or more of a camera, a scanner, or a voice recognition module.

15. A system for generating medical information, the system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instruction to identify a medical document;
program instruction to annotate the medical document using a plurality of annotators to produce annotations associated with the medical document;
program instruction to determine a medical condition based, at least in part, on the annotations; and
program instruction to generate medical information related to the medical condition based, at least in part, on the annotations.

16. The system of claim 15, further comprising:
program instruction to identify a knowledge domain of the medical document.

17. The system of claim 16, further comprising:
program instruction to identify at least one of the annotators based on the knowledge domain of the medical document.

18. The system of claim 15, wherein the medical information includes one or more of a patient awareness report and a follow-up question.

19. The system of claim 15, wherein determining the medical condition includes searching for at least one of the annotations in a medical database.

20. The system of claim 19, wherein the medical database includes an ontology.
